(19) United States
(12) Patent Application Publication
(10) Pub. No.: US 2025/0212149 A1
(43) Pub. Date: Jun. 26, 2025

(54) METHOD AND DEVICE FOR COMMUNICATION IN WIRELESS COMMUNICATION SYSTEM SUPPORTING PERSONAL IOT NETWORK

(71) Applicant: SAMSUNG ELECTRONICS CO., LTD., Suwon-si, Gyeonggi-do (KR)

(72) Inventors: Lalith KUMAR, Bangalore (IN); Sidhant JAIN, Bangalore (IN); Aman AGARWAL, Bangalore (IN); Kailash Kumar JHA, Bangalore (IN); Anoop P V, Bangalore (IN)

(21) Appl. No.: 18/849,981

(22) PCT Filed: Mar. 23, 2023
(86) PCT No.: PCT/KR2023/003898

§ 371 Date: Sep. 23, 2024

(30) Foreign Application Priority Data
Mar. 23, 2022 (IN) 202241016201
Mar. 14, 2023 (IN) 202241016201

(51) Int. Cl. H04W 60/00; H04W 84/18

(52) U.S. Cl. CPC H04W 60/00; H04W 84/18

(57) ABSTRACT

Embodiments of the disclosure provides to a method and device for provisioning PIN subscription data in a wireless communication system supporting a personal IoT network (PIN). The method performed by a user equipment (UE) in a wireless communication system supporting the PIN, the method comprises transmitting, to a mobility management function (AMF), a registration request message including PIN input information, and receiving, from the AMF, a registration accept message including PIN subscription data based on the PIN input information, wherein the UE in the PIN acts as at least one of a PIN element with gateway capability (PEGC) device and a PIN element with management capability (PEMC) device.

### TECHNICAL FIELD

The present disclosure generally relates to Internet of Things (IoT) and more specifically relates to a method and a system for handling a Personal IoT Network (PIN).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In general, Internet of Things (IoT) is a concept of connecting any device to the internet and to other connected devices or User Equipments (UEs). The IoT system is a massive network of interconnected devices and users. The Internet of Things (IoT) system collects and shares data with each other. The IoT system also provides information about how interconnected devices may utilize the data and environment around them. For example, a smart microwave automatically cooks food for the appropriate amount of time, a self-driving car detects an object in its path and wearable fitness devices that measure heart rate and the number of steps taken that day and then use that information to suggest exercise plans. Accordingly, the IoT devices are classified into categories e.g., an IoT device(s) in a home, and an IoT device(s) on a user, etc. The IoT device(s) from both categories that communicate within a meter or two with each other and with an external network (e.g., evolved NodeB (eNB), core network entity, etc.) via a local gateway are referred to as a Personal IoT Network (PIN). For example, when the user connects to a car using a smartphone or another IoT device, the PIN is generated.

### DISCLOSURE OF INVENTION

### Technical Problem

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

In the existing system, the core network entity (e.g., Unified Data Management/Policy Control Function (UDM/PCF) or PIN server) stores a PIN subscription/PIN configuration of the UEs (e.g., IoT devices). There are some limitations/drawbacks to the existing system. For example, the existing system does not describe a process for fetching the stored PIN subscription/PIN configuration for the UEs from the core network entity, a process for classifying/propagating the stored PIN subscription/PIN configuration for various types of UEs (e.g., PIN Element with Gateway Capability (PEGC), PIN Element with Management Capability (PEMC), and PIN Elements (PINEs), and a process for utilizing the stored PIN subscription/PIN configuration to manage the PIN and to allow/disallow the PINEs in the PIN.

Thus, it is desired to address the above-mentioned disadvantages or other shortcomings or at least provide a useful alternative for handling the PIN.

The disclosure provides to a method and device for provisioning PIN subscription data in a wireless communication system supporting the PIN.

### Solution to Problem

According to one embodiment of the present disclosure, a method performed by a user equipment (UE) in a wireless communication system supporting a personal IoT network (PIN) is disclosed, the method comprises transmitting, to a mobility management function (AMF), a registration request message including PIN input information, and receiving, from the AMF, a registration accept message including PIN subscription data based on the PIN input information, wherein the UE in the PIN acts as at least one of a PIN element with gateway capability (PEGC) device and a PIN element with management capability (PEMC) device.

In an embodiment, wherein the PIN input information includes at least one of a PIN-ID of the UE, information indicating that the UE wants to be as the PEGC device, and information indicating that the UE wants to be as the PEMC device.

In an embodiment, wherein the PIN subscription data for the PEGC device includes at least one of one or more PIN-IDs which are a kind of group ID, information representing a threshold of a maximum number of PIN element (PINE) allowed for the PEGC device, information representing per PINE max duration allowed to be retained in the PIN after the PINE has joined the PIN, information representing an applicable time slot for the PEGC device, information representing max duration for the PEGC device after the UE starts behaving as the PEGC device, information representing maximum duration per PIN-ID, the maximum duration being a time till the UE acts as the PEGC device, and information representing a time slot per PIN-ID for which the PIN-ID is valid for the PEGC device.

In an embodiment, wherein the PIN subscription data for the PEMC device includes at least one of one or more PIN-IDs which are a kind of group ID, information representing a threshold of a maximum number of PIN element (PINE) or PEGC device allowed for the PEMC device, information representing per PINE max duration allowed to be retained in the PIN after the PINE has joined the PIN, information representing an applicable time slot for the PEMC device, information representing max duration for the PEMC device after the UE starts behaving as the PEMC device, information representing maximum duration per PIN-ID, the maximum duration being a time till the UE acts as the PEMC device, and information representing a time slot per PIN-ID for which the PIN-ID is valid for the PEMC device.

In an embodiment, wherein a PEGC device having a lower priority is removed in the PIN based on a threshold in case that the PEGC device joining the PIN has a higher priority among PEGC devices.

In an embodiment, wherein the PEGC device is a PIN element with an ability to provide connectivity to the wireless communication system, and wherein the PEMC device is a PIN element with capability to manage the PIN.

According to one embodiment of the present disclosure, a user equipment (UE) in a wireless communication system supporting a personal IoT network (PIN) is disclosed, the UE comprises a communicator, and a processor configured to transmit, to a mobility management function (AMF) via the communicator, a registration request message including PIN input information, and receive, via the communicator from the AMF, a registration accept message including PIN subscription data based on the PIN input information, wherein the UE in the PIN acts as at least one of a PIN element with gateway capability (PEGC) device and a PIN element with management capability (PEMC) device.

According to one embodiment of the present disclosure, a method performed by a mobility management function (AMF) in a wireless communication system supporting a personal IoT network (PIN) is disclosed, the method comprises receiving, from a user equipment (UE), a registration request message including PIN input information, receiving, from a unified data management (UDM), PIN subscription data based on the PIN input information, and transmitting, to the UE, a registration accept message including the PIN subscription data, wherein the UE in the PIN acts as at least one of a PIN element with gateway capability (PEGC) device and a PIN element with management capability (PEMC) device.

According to one embodiment of the present disclosure, a mobility management function (AMF) in a wireless communication system supporting a personal IoT network (PIN) is disclosed, the AMF comprises a communicator, and a processor configured to receive, via the communicator from a user equipment (UE), a registration request message including PIN input information, receive, via the communicator from a unified data management (UDM), PIN subscription data based on the PIN input information, and transmit, to the UE via the communicator, a registration accept message including the PIN subscription data, wherein the UE in the PIN acts as at least one of a PIN element with gateway capability (PEGC) device and a PIN element with management capability (PEMC) device.

According to one embodiment of the present disclosure, a method for handling a Personal IoT Network (PIN) is disclosed. The method includes sending, by a User Equipment (UE) registered in the PIN, PIN input information to a network device through a first message. The method further includes receiving, by the UE, PIN management information through a second message from the network device in response to the sent PIN input information. The method further includes handling, by the UE, a plurality of UEs registered in the PIN based on the received PIN management information.

According to another embodiment of the present disclosure, a method for handling the PIN is disclosed. The method includes receiving, by the network device, the PIN input information from the UE registered in the PIN through the first message. The method further includes determining, by the network device, the PIN management information based on the received first message. The method further includes sending, by the network device, the PIN management information to the UE through the second message, wherein the UE handles the PIN based on the received PIN management information.

According to another embodiment of the present disclosure, a system for handling the PIN is disclosed. The system includes a UE-PIN controller coupled with a processor and a memory. The UE-PIN controller sends the PIN input information to the network device through the first message. The UE-PIN controller receives the PIN management information through the second message from the network device in response to sending the first message. The UE-PIN controller handles the plurality of UEs registered in the PIN based on the received PIN management information.

According to another embodiment of the present disclosure, a system for handling the PIN is disclosed. The system includes a network-PIN controller coupled with a processor and a memory. The network-PIN controller receives the PIN input information from the UE registered in the PIN through the first message. The network-PIN controller determines the PIN management information based on the received first message. The network-PIN controller sends the PIN management information to the UE through the second message, wherein the UE handles the PIN based on the received PIN management information.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an operational sequential diagram associated with a system for a successful case to obtain PIN subscription data in order to handle a Personal IoT Network (PIN), according to an embodiment as disclosed herein;

FIGS. 2A and 2B illustrate operational sequential diagrams associated with the system for a failure case to obtain the PIN subscription data in order to handle the PIN, according to an embodiment as disclosed herein;

FIG. 3 illustrates a block diagram of a User Equipment (UE) for handling the PIN, according to an embodiment as disclosed herein;

FIG. 4 illustrates a block diagram of a network device for handling the PIN, according to an embodiment as disclosed herein;

FIG. 5 is a flow diagram illustrating a method for the UE to handle the PIN, according to an embodiment as disclosed herein;

FIG. 6 is a flow diagram illustrating a method for allowing or removing at least one PINE device of a plurality of PINE devices in the PIN based on a value of a maximum PINE number threshold, according to an embodiment as disclosed herein;

FIG. 7 is a flow diagram illustrating a method for allowing or removing at least one PINE device of a plurality of PINE devices in the PIN based on a value of a maximum PINE duration, according to an embodiment as disclosed herein;

FIG. 8 is a flow diagram illustrating a method for configuring the UE as the PEGC device based on a predefined time slot, according to an embodiment as disclosed herein;

FIG. 9 is a flow diagram illustrating a method for configuring the UE as the PEGC device based on a value of a maximum PEGC duration, according to an embodiment as disclosed herein;

FIG. 10 is a flow diagram illustrating a method for configuring the UE as the PEGC device based on a value of the maximum duration for each PIN-ID, a predefined time slot for each PIN-ID, and a value of a maximum threshold for each PIN-ID, according to an embodiment as disclosed herein;

FIG. 11 is a flow diagram illustrating a method for configuring the UE as the PEMC device based on the predefined time slot, according to an embodiment as disclosed herein;

FIG. 12 is a flow diagram illustrating a method for configuring the UE as the PEMC device based on a value of a maximum PEMC duration, according to an embodiment as disclosed herein;

FIG. 13 is a flow diagram illustrating a method for configuring the UE as the PEMC device based on the value of the maximum duration for each PIN-ID, the predefined time slot for each PIN-ID, and the value of a maximum threshold for each PIN-ID, according to an embodiment as disclosed herein;

FIG. 14 is a flow diagram illustrating a method for handling the PIN based on a priority of the PEGC device, according to an embodiment as disclosed herein;

FIG. 15 is a flow diagram illustrating a method for the network device to handle the PIN, according to an embodiment as disclosed herein; and

FIG. 16 is a flow diagram illustrating a method for sending a reject cause by the network device to the UE based on a validation of PIN input information, according to an embodiment as disclosed herein.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

In the disclosure, the user equipment (UE) may refer to a terminal, MS (mobile station), cellular phone, smartphone, computer, or various electronic devices capable of performing communication functions. According to the disclosure, the base station may be an entity allocating a resource to the UE and may be at least one of a gNode B, gNB, eNode B, eNB, Node B, BS, radio access network (RAN), base station controller, or node on network.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Unlike existing methods, the disclosed method enables a User Equipment (UE) to operate as, for example, a PEGC device and/or a PEMC device to provide one or more 3GPP services to one or more non-3GPP devices and to manage one or more 3^{rd} Generation Participation Project (3GPP) services for one or more non-3GPP devices in the PIN. As a result, one or more non-3GPP devices use the PIN to access one or more 3GPP services, while the UE manages the PIN. The definitions of various terms discussed throughout the disclosure are listed in the table-1 below.

TABLE 1

| Terms | Definitions |
|---|---|
| Personal | The PIN provides local connectivity between UEs and/or |
| IoT | non-3GPP devices. The PIN consists of PIN Elements |
| Network | (PINE) that communicate using PIN direct connection or |
| (PIN) | direct network connection and is managed locally (using |
| | a PIN element with management capability). |
| | The PIN denotes a configured and managed group of PIN |
| | Element that are able to communicate each other directly |
| | or via PIN Elements with Gateway Capability (PEGC), |
| | communicate with 5G network via at least one PEGC, and |
| | managed by at least one PIN Element with Management |
| | Capability (PEMC) |
| PIN | PIN Elements are UEs and/or non-3GPP devices that form |
| Element | part of the PIN. |
| (PINE) | A UE or non-3GPP device that can communicate within a |
| | PIN (via PIN direct connection, via PEGC, or via PEGC |
| | and 5GC), or outside the PIN via a PEGC and 5GC. |
| PIN Element | PIN Element which can provide means for an authorized |
| with | administrator to configure and manage the PIN. |
| Management | A PIN Element with capability to manage the PIN. |
| Capability | |
| (PEMC) | |
| PIN Element | PIN Elements with gateway capability provide means for |
| with | the PINE to register and access 5G network services. |
| Gateway | Which may also help in communication between two PIN |
| Capability | elements that are not within a range to use direct |
| (PEGC) | communication. |
| | A PIN Element with the ability to provide connectivity to |
| | and from the 5G network for other PIN Elements, or to |
| | provide relay for the communication between PIN |
| | Elements. |
| Identity of | A unique identifier is associated with the PIN. |
| PIN | |
| (PIN-ID) | |
| ProSe | ProSe is a D2D (Device-to-Device) technology that allows |
| (Proximity | LTE devices to detect each other and to communicate |
| Services) | directly |

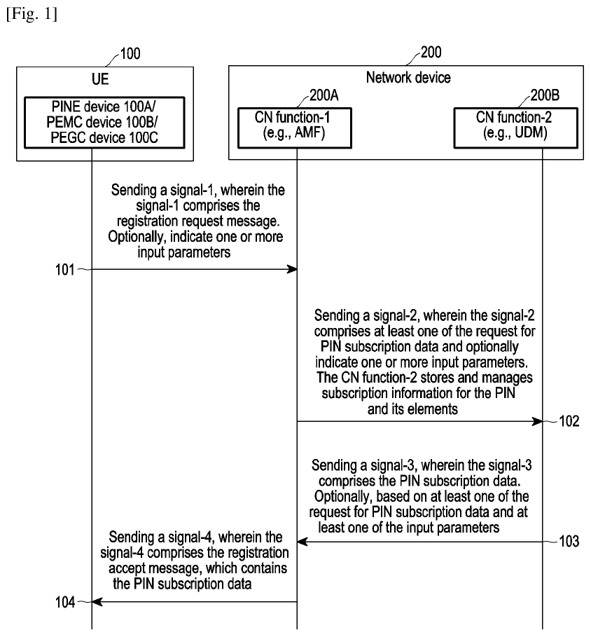

Referring now to the drawings, and more particularly to FIGS. 1 to 16, where similar reference characters denote corresponding features consistently throughout the figures, there are shown preferred embodiments.

FIG. 1 illustrates an operational sequential diagram associated with a system for a successful case to obtain PIN subscription data in order to handle a Personal IoT Network (PIN), according to an embodiment as disclosed herein. The system includes, for example, a User Equipment (UE) (100) and a network device(s) (200) that are operatively connected with each other.

Examples of the UE (100) include, but are not limited to, a smartphone, a tablet computer, a Personal Digital Assistance (PDA), an Internet of Things (IoT) device, a wearable device, etc. The UE (100) is configured as a PIN Element (PINE) device (100A) or a PIN Element with Management Capability (PEMC) device (100B) or a PIN Element with Gateway Capability (PEGC) device (100C) to handle the PIN, as discussed throughout the disclosure.

Examples of the network device(s) (200) include, but are not limited to, a Core Network (CN) function-1 (200A) (Access & Mobility Management Function (AMF)), a CN function-2 (200B) (Unified Data Management (UDM)), and a PIN server. The UDM manages subscription data for UEs.

To handle the PIN, the system performs several operations, which are detailed in a step-by-step procedure. At step 101, the UE (100) sends a signal-1 (i.e., first message) to the CN function-1 (200A), wherein the signal-1 comprises a registration request message. Optionally, the registration request message may indicates/includes one or more input parameters (i.e., PIN input information). The CN function-1 (200A) may manage a PIN session, a registration, and a mobility context. The PIN input information may be referred to simply as PIN information.

The PIN input information comprises at least one of configuration information of the UE (100), an identity of PIN (PIN-ID), a request for PIN subscription data, a type of the UE (100), a type of service associated (i.e. supported) with the UE (100), a characteristic of the UE (100), an identity of group (group-ID), a capability of the UE (100) and an entity indication associated with the UE (100). The entity indication of the UE (100) indicates at least one of a requesting entity (i.e., UE (100)) needs to be (or anchor) as the PEGC device (100C), the requesting entity needs to be (or anchor) as the PEMC device (100B), the requesting entity needs to be (or anchor) as both the PEMC device (100B) and the PEGC device (100C), the requesting entity can indicate the PIN ID(identity) for which the requesting entity wants to be (or anchor) as at least one of the PEMC device (100B) and the PEGC device (100C), and the requesting entity can indicate that “the requesting entity wants to be the PINE device (100A) of the PIN ID”.

At step 102, the CN function-1 (200A) sends a signal-2 to the CN function-2 (200B), wherein the signal-2 comprises at least one of the request for the PIN subscription data and optionally indicate one or more input parameters. Upon receiving the signal-2, the CN function-2 (200B) stores and manages subscription information for the PIN and its elements (i.e., received PIN input information).

At step 103, the CN function-2 (200B) sends a signal-3 (e.g., second message) to the CN function-1 (200A), wherein the signal-3 comprises the PIN subscription data or said PIN management information. Optionally, based on at least one of the request for the PIN subscription data and at least one of the input parameters. Or based on subscription information of the UE (100) (e.g., the PINE device (100A), the PEMC device (100B), and the PEGC device (100C)). The PIN management information is determined based on the received PIN input information.

At step 104, the CN function-1 (200A) sends a signal-4 (e.g., second message) to the UE (100), wherein the signal-4 comprises the registration accept message or said PIN management information. The registration accept message includes the PIN management information. The PIN management information comprises PIN subscription data, the PIN subscription data comprises at least one of one or more PIN identities (PIN-IDs), a maximum PINE number threshold, a maximum PINE duration, a predefined time slot, a maximum PEGC duration, and a maximum PEMC duration, a maximum duration for each PIN-ID, a time slot information for each PIN-ID, and a maximum threshold for each PIN-ID.

As mentioned in the step 104, the received PIN subscription data for the PEGC device (100C includes one or more parameters to handle the PIN, which are listed below.

a. One or more PIN-IDs: One or more PIN-IDs is a kind of a group id. This identifies collectively PINE device(s) (100A) which have common PIN characteristics based on a subscription, a type of device, and a type of service. Furthermore, the PIN-ID identifies the PIN.

b. Max number threshold (i.e., the maximum PINE number threshold): a threshold of a maximum number of the PINE device(s) (100A) allowed per PIN-ID (or PIN Group ID in short it can be referred to as the PIN) or for the PEGC device (100C) for all the PIN-IDs. The PEGC device (100C) enforces max number threshold of the PINE device(s) (100A) (optionally as per characteristics of the PIN for example identified by the PIN-ID/optionally counting at least one of the PEGC device (100C) and the PEMC device (100B) as part of the threshold). When the threshold is reached the PEGC device (100C) indicates the same and provides a back-off timer, the PINE device(s) (100A)/the PEMC device (100B) re-tries after the back-off timer expires.

c. Per PINE Max duration (i.e., the maximum PINE duration): After the PINE device(s) (100A) has joined the PIN, the PINE Max duration indicates a duration for which the PINE device(s) (100A) is allowed to be retained in the PIN by the PEGC device (100C). The PEGC device (100C) removes the PINE device(s) (100A) from the PIN when the PINE max duration is reached. The PINE device(s) (100A) can release from the PEGC device (100C) when the PINE max duration is reached.

d. Applicable time slot (i.e., the predefined time slot): For the PEGC device (100C), for all the PIN-IDs. i.e., the PEGC device (100C) may stop being a gateway if the PEGC device (100C) is not in the applicable time slot/allowed time slot. If the PEMC device (100B) attempts to add the PEGC device (100C) in the PIN during a non-allowed time slot an appropriate reject cause is provided to the PEMC device (100B) so that the PEMC device (100B) can select some other PEGC device for the PIN-ID.

e. Max duration for the PEGC device (100C) (i.e., the maximum PEGC duration): After the UE (100) starts behaving as the PEGC device (100C) or received a signalled from the PEMC device (100B) or a 5^{th} Generation Core Network (5GC) NF that the UE (100) should act as the PEGC device (100C) for the maximum duration, after which the UE (100) should cease to act as the PEGC device (100C) release all the PINE, indicate the same to the PEMC device (100B) or the 5GC NF.

f. Per PIN-ID:

f-1. Maximum duration (i.e., the maximum duration for each PIN-ID): Maximum duration is a time when the PEGC device (100C) is set up for the given PIN-ID i.e., a start time to the “maximum duration” in the subscription; once the time is expired the PEGC device (100C) may stop acting as the PEGC device (100C) for the respective PIN-ID; or

f-2. Time slot (start time-end time) for which the PIN-ID (i.e., the time slot information for each PIN-ID) is valid for the PEGC device (100C). The PEGC device (100C) may stop or cease to act as the PEGC device (100C) for that PIN-ID if it's not in the allowed time slot. The PEGC device (100C) removes all the PINEs (PINE device(s) (100A)) from the PIN when the PIN-ID max duration is reached or the PEGC device (100C) is not in the allowed time slot. If the PINE device(s) (100A)/PEMC device (100B) makes a request outside the timeslot, the PINE device(s) (100A) is rejected with an appropriate reject cause or indication that the PIN-ID is not available in the time slot and optionally indicates the time slot the PIN-ID is applicable.

In one embodiment, the PINE device(s) (100A) may try to join the PIN only in the allowed time slot or for the maximum duration, based on the received information from the network device (200).

In one embodiment, the priorities of the PINE device(s) (100A) and the PEMC device (100B) are determined based on, for example, the subscription, the type of devices (e.g., UE (100)), and the type of service.

In one embodiment, the PINE device(s) (100A) can be assigned priority, which may be used when a threshold is reached. Pre-emption of the PINE device(s) (100A) based on priorities. Assign the PINE device(s) (100A)/PEMC device (100B) based on the priorities and re-assign the PINE device(s) (100A)/PEMC device (100B) based on priorities. Also, if a higher priority PINE device(s) (100A) joins the PIN and the max number threshold is reached for the PIN, the PEGC device (100C) removes a lower priority PINE device(s) (100A) to make space for the higher priority PINE device(s) (100A).

In one embodiment, PEGC slice subscription data is determined based on, for example, input parameters like the subscription, the type of devices, and the type of service.

In one embodiment, the PEGC device (100C)/PEMC device (100B)/PINE device(s) (100A) can receive a reject cause based on the type of device or type of service or characteristics or device capability, capability, group id, and indicate the UE (100) is not allowed to join the PIN. Then, respective input parameters should not be requested by the PINE device(s) (100A)/PEGC device (100C)/PEMC device (100B) for a specific time, till a Universal Subscriber Identity Module (USIM) of the UE (100) is removed, etc., or switch off and switch on (i.e., power cycle).

In general, the specific time is determined by a timer for any of the features in this embodiment can be pre-configured in the UE (100) or signalled by the network device (200) or the specific time can be chosen based on the implementation in the UE (100).

As mentioned in the step 104, the received PIN subscription data for the PEMC device (100B) includes one or more parameters to handle the PIN, which are listed below.

a. One or more PIN-IDs: One or more PIN-IDs is a kind of a group id. This identifies collectively PINE device(s) (100A) which have common PIN characteristics based on the subscription, the type of device, and the type of service. Furthermore, the PIN-ID identifies the PIN.

b. Max number threshold (i.e., the maximum PINE number threshold): a threshold of a maximum number of the PINE device(s) (100A) allowed per PIN-ID (or PIN group ID in short it can be referred to as the PIN) or for the PEMC device (100B) for all the PIN-IDs. The PEMC device (100B) enforces max number threshold of PINEs (optionally as per characteristics of the PIN for example identified by PIN-ID) (optionally counting at least one of the PEGC and PEMC entity as part of the threshold). When the threshold is reached the PEMC device (100B) indicates the same and provides the back-off timer, the PINE device(s) (100A)/the PEGC device (100C) re-tries after the back-off timer expires.

c. Per PINE Max duration (i.e., the maximum PINE duration): After the PINE device(s) (100A) has joined the PIN, the PINE Max duration indicates a duration for which the PINE device(s) (100A) is allowed to be retained in the PIN by the PEMC device (100B). The PEMC device (100B) removes the PINE device(s) (100A) from the PIN when the PINE max duration is reached. The PINE device(s) (100A) can release from THE PIN when the PINE max duration is reached.

d. Applicable time slot (i.e., the predefined time slot): for the PEMC device (100B) for all the PIN-IDs. i.e., the PEMC device (100B) may stop being the management entity if it's not in the allowable time slot. If the PEGC device (100C) attempts to add the PEMC device (100B) in the PIN during a non-allowed time slot an appropriate reject cause is provided to the PEGC device (100C) so that the PEGC device (100C) can select some other PEMC device (100B) for the PIN-ID.

e. Max duration for the PEMC device (100B) (i.e., the maximum PEMC duration): After the UE (100) starts behaving as the PEMC device (100B) or received a signalled from the PEGC device (100C) or 5GC NF that the UE (100) should act as the PEMC device (100B), then for the maximum duration the UE (100) should act as the PEMC device (100B) after which the UE (100) should cease to act as the PEMC device (100B) release all the PINE device (100A), indicate the same to the PEGC device (100C) or 5GC NF.

f. Per PIN-ID:

f-1. Maximum duration (i.e., the maximum duration for each PIN-ID): Maximum duration is the time when the PEMC device (100B) is set up for the given PIN-ID i.e., a start time to the “maximum duration” in the subscription; once the maximum duration is expired, the PEMC device (100B) may stop acting as the PEMC device (100B) for the respective PIN-ID; or

f-2. Time slot (start time-end time) for which the PIN-ID (i.e., time slot information for each PIN-ID) is valid for the PEMC device (100B). The PEMC device (100B) may stop or cease to act as the PEMC device (100C) for that PIN-ID if it's not in the allowed time slot. The PEMC device (100B) removes all the PINEs (PINE device(s) (100A)) from the PIN when PIN-ID max duration is reached. Or the UE (100) is not in the allowed timeslot. If PINE device(s) (100A)/PEGC device (100C) makes a request outside the timeslot PINE device(s) (100A)/PEGC device (100C) is rejected with an appropriate reject cause or indication that PIN-ID is not available in the time slot and optionally indicate the time slot the PIN-ID is applicable.

In one embodiment, the PINE device(s) (100A) may try to join the PIN only in the allowed time slot or for the maximum duration, based on the received information from the network device (200).

In one embodiment, the priorities of the PINE device(s) (100A) and the PEMC device (100B) are determined based on, for example, the subscription, the type of devices (e.g., UE (100)), and the type of service.

In one embodiment, the PINE device(s) (100A) can be assigned priority, which may be used when a threshold is reached. Pre-emption of the PINE device(s) (100A) based on priorities. Assign the PINE device(s) (100A)/PEGC device (100C) based on the priorities and re-assign the PINE device(s) (100A)/PEGC device (100C) based on priorities. Also, if a higher priority PINE device(s) (100A) joins the PIN and the max number threshold is reached for the PIN, the PEMC device (100B) removes the lower priority PINE device(s) (100A) to make space for the higher priority PINE device(s) (100A).

In one embodiment, PEMC slice subscription data is determined based on, for example, input parameters like the subscription, the type of devices, and the type of service.

In one embodiment, the PEGC device (100C)/PEMC device (100B)/PINE device(s) (100A) can receive the reject cause based on the type of device or type of service or characteristics or device capability, capability, group ID and indicate, the UE (100) is not allowed to join the PIN. The respective input parameters should not be requested by the PINE device(s) (100A)/PEGC device (100C)/PEMC device (100B) for a specific time, till the USIM of the UE (100) is removed etc, or switched off and switch on (i.e., power cycle).

In general, the specific time determined by the timer for any of the features in this embodiment can be pre-configured in the UE (100) or signalled by the network device (200), or the network device (200) can be chosen based on the implementation in the UE (100).

As mentioned in step 104, the received PIN subscription data for the PINE device(s) (100A) includes one or more parameters to handle the PIN, which are listed below.

a. One or more PIN-IDs: One or more PIN-IDs is a kind of group id. This identifies collectively PINE device(s) (100A) which have common PIN characteristics based on the subscription, the type of devices, and the type of service. Furthermore, the PIN-ID identifies the PIN.

b. Max number threshold (i.e., the maximum PINE number threshold): a threshold of a maximum number of the PINE device(s) (100A) allowed per PIN-ID (or PIN Group ID in short it can be referred to as the PIN) or for the PINE device(s) (100A) for all the PIN-IDs. The PINE device(s) (100A) enforces max number threshold of PINEs (optionally as per characteristics of the PIN for example identified by PIN-ID) (optionally counting at least one of the PEGC device (100C) and the PEMC device (100B) as part of the threshold). When the threshold is reached PEMC device (100B) may indicate the same and provides a back-off timer, and the PINE device(s) (100A)/PEGC device (100C) re-tries after the back-off timer expires.

c. Per PINE Max duration (i.e., the maximum PINE duration): After the PINE device(s) (100A) has joined the PIN, the PINE Max duration indicates a duration for which the PINE device(s) (100A) is allowed to be retained in the PIN by the PEMC device (100B)/PEGC device (100C). The PEMC device (100B)/PEGC device (100C) removes the PINE device(s) (100A) from the PIN when the PIN element max duration is reached. The PINE device(s) (100A) can release from the PIN when the PINE max duration is reached.

d. Applicable time slot (i.e., the predefined time slot): for the PINE device(s) (100A), for all the PIN-IDs. i.e., the PINE device(s) (100A) may stop being the PINE device(s) (100A) for the PIN if it's not in the allowable time slot. If the PEGC device (100C)/PEMC device (100B) attempts to add PINE in the PIN during a non-allowed time slot an appropriate reject cause is provided to the PEGC device (100C)/PEMC device (100B) so that the PEGC device (100C)/PEMC device (100B) can select some other PINE device(s) (100A) for the PIN-ID.

e. Max duration for PINE device(s) (100A): After the UE (100) starts behaving as the PINE device(s) (100A) or received a signalled from the PEGC device (100C)/PEMC device (100B) or 5GC NF that the UE (100) should act as the PINE device(s) (100A), then for the maximum duration the UE (100) should be part of the PIN after which the UE (100) should release itself from the PIN and indicate the same to the PEGC device (100C)/PEMC device (100B) or 5GC NF.

f. Per PIN-ID:

f-1. Maximum duration (i.e., the maximum duration for each PIN-ID): Maximum duration is the time when the PINE device(s) (100A) is set up for the given PIN-ID i.e., a start time to the “maximum duration” in subscription; once the maximum duration is expired, the PINE device(s) (100A) may release itself from the respective PIN-ID; or

f-2. Time slot (start time-end time) for which a PIN-ID (i.e., the time slot information for each PIN-ID) is valid for the PINE device(s) (100A). The PINE device(s) (100A) may stop being the PINE device(s) (100A) for that PIN-ID if it's not in the allowed time slot. The PINE device(s) (100A) removes all the PINEs (PINE device(s) (100A)) from the PIN when the PIN-ID max duration is reached. Or the UE (100) is not in the allowed timeslot. If the PEGC device (100C)/PEMC device (100B) makes a request outside the timeslot, the PEGC device (100C)/PEMC device (100B) is rejected with an appropriate reject cause or indication that PIN-ID is not available in the time slot and optionally indicates the time slot the PIN-ID is applicable.

In one embodiment, the PEGC device (100C)/PEMC device (100B) may try to join the PIN only in the allowed time slot or for the maximum duration, based on the received information from the network device (200).

In one embodiment, the priorities of the PEGC device (100C) and the PEMC device (100B) are determined based on, for example, the subscription, the type of devices (e.g., UE (100)), and the type of service.

In one embodiment, the PEGC device (100C)/PEMC device (100B) can be assigned priority, which may be used when the threshold is reached. Pre-emption of the PEGC device (100C)/PEMC device (100B) based on priorities. Assign the PEGC device (100C)/PEMC device (100B) based on the priorities and re-assign the PEGC device (100C)/PEMC device (100B) based on priorities. Also, if a higher priority PEGC device (100C)/PEMC device (100B) joins the PIN and the max number threshold is reached for the PIN, the PINE device(s) (100A) removes a lower priority PEGC device (100C)/PEMC device (100B) to make space for the higher priority PEGC device (100C)/PEMC device (100B).

In one embodiment, PINE slice subscription data is determined based on, for example, input parameters like the subscription, the type of devices, and the type of service.

In one embodiment, the PEGC device (100C)/PEMC device (100B)/PINE device(s) (100A) can receive the reject cause based on the type of device or type of service or characteristics or device capability, capability, group id, and indicate that the UE (100) is not allowed to join the PIN. Then, respective input parameters should not be requested by the PINE device(s) (100A)/PEGC device (100C)/PEMC device (100B) for a specific time, till the USIM of the UE (100) is removed, etc., or switch off and switch on (i.e., power cycle).

In general, the specific time is determined by a timer for any of the features in this embodiment can be pre-configured in the UE (100) or signalled by the network device (200) or the specific time can be chosen based on the implementation in the UE (100).

In one embodiment, an example of the type of service includes, but is not limited to, an enhanced Mobile Broadband (eMBB), an ultra-reliable low latency communication (URLLC), a massive internet of things (MIoT) or IoT, a Vehicle-to-everything (V2X) services, and high-performance machine-type communications. In one embodiment, an example of the type of device includes, but is not limited to, a printer, a thermostat, and any device which can support the “type of service” listed above. In one embodiment, an example of the characteristic includes any device which can handle the “type of service” listed above. In one embodiment, the group ID indicates a kind of PIN-ID who wants to join the PIN. In one embodiment, capability (capability like printer, etc.) or the capability of the devices which can support the “type of service”, or “type of devices” listed above.

In one embodiment, PEGC PIN subscription data and PEMC PIN subscription data described can also be configured by an authorized user in the PEGC device (100C) and/or PEMC device (100B).

In one embodiment, the UDM provides the subscription data to the PEGC device (100C)/PEMC device (100B) but the same information can be considered as policy and provided by a Policy Control Function (PCF) to the PEGC device (100C)/PEMC device (100B) after the UE (100) has completed the registration procedure. The UDM and PCF are all example entities, subscription data can be provided by any entity managing the PIN to the UE (100) (i.e., PEGC device (100C), PEMC device (100B) or the PINE device (100A)).

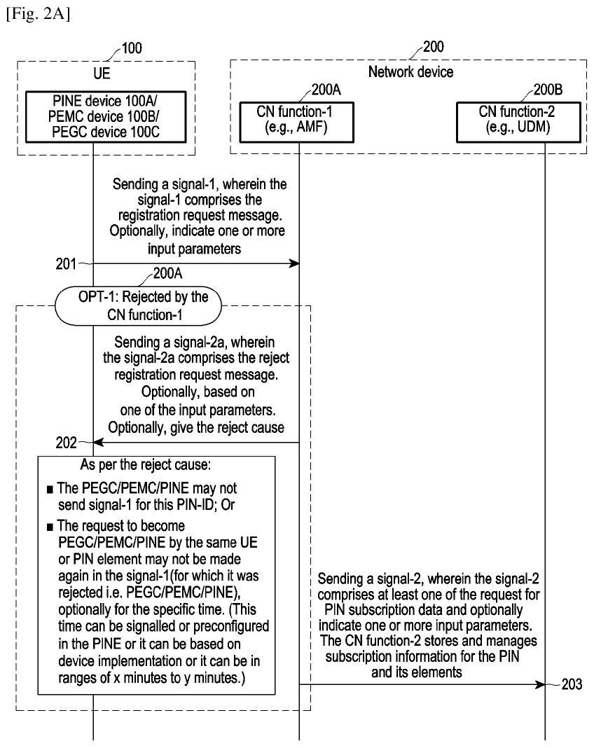

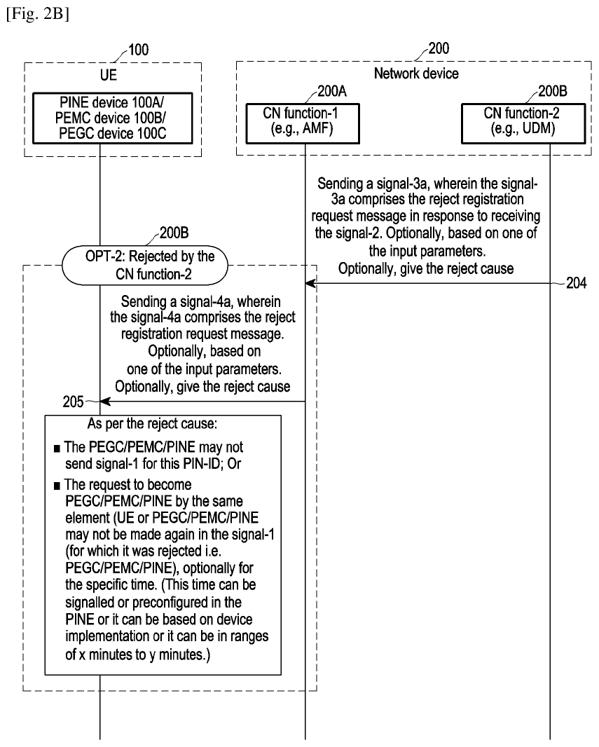

FIGS. 2A-2B illustrates operational sequential diagrams associated with the system for a failure case to obtain the PIN subscription data in order to handle the PIN, according to an embodiment as disclosed herein.

To handle the PIN, the system performs several operations, which are detailed in a step-by-step procedure. At step 201, the UE (100) sends the signal-1 (i.e., first message) to the CN function-1 (200A), wherein the signal-1 comprises the registration request message. Optionally, indicate one or more input parameters (i.e., PIN input information). The CN function-1 (200A) may manage the PIN session, the registration, and the mobility context.

At step 202, the CN function-1 (200A) sends a signal-2a, wherein the signal-2a comprises a reject registration request message. Optionally, based on one of the input parameters. Optionally, give a reject cause. The reject cause can be related to the PIN session, mobility, etc. As per the reject cause, the UE (100) has to follow certain requirements/suggestions received from the CN function-1 (200A), which are listed below.

a. The PEGC device (100C)/PEMC device (100B)/PINE device (100A) may not send the signal-1 for the PIN-ID; or

b. The request to become the PEGC device (100C)/PEMC device (100B)/PINE device (100A) by the same UE (100) or PIN element should not be made again in signal 1 (for which it was rejected i.e., PEGC device (100C)/PEMC device (100B)/PINE device (100A)), optionally for a specific time. (The specific time can be signalled or preconfigured in the PEGC device (100C)/PEMC device (100B)/PINE device (100A), or the specific time can be based on device implementation, or the specific time can be in ranges of x minutes to y minutes).

At step 203, the CN function-1 (200A) sends the signal-2 to the CN function-2 (200B) when the UE (100) has followed certain requirements/suggestions received from the CN function-1 (200A) as mentioned in the step 202, wherein the signal-2 comprises at least one of the request for the PIN subscription data and optionally indicate one or more input parameters. The CN function-2 (200B) stores and manages subscription information for the PIN and its elements.

At step 204, the CN function-2 (200B) sends a signal-3a to the CN function-1 (200A), wherein the signal-3a comprises the reject registration request message in response to receiving the signal-2. Optionally, based on one of the input parameters. Optionally, give the reject cause. The reject cause can be related to PIN subscription issues.

At step 205, the CN function-1 (200A) sends a signal-4a to the UE (100), wherein the signal-4a comprises the reject registration request message. Optionally, based on one of the input parameters. Optionally, give the reject cause. As per the reject cause, the UE (100) has to follow certain requirements/suggestions received from the CN function-1 (200A), which are listed below.

a. The PEGC device (100C)/PEMC device (100B)/PINE device (100A) may not send signal-1 for the PIN-ID; or

b. The request to become the PEGC device (100C)/PEMC device (100B)/PINE device (100A) by the same UE (100) or PIN element (PEGC device (100C)/PEMC device (100B)/PINE device (100A)) should not be made again in the signal-1 (for which the UE (100) was rejected i.e., PEGC device (100C)/PEMC device (100B)/PINE device (100A)), optionally for a specific time. (The specific time can be signalled or preconfigured in the PINE, or the specific time can be based on device implementation, or the specific time can be in ranges of x minutes to y minutes).

Following reject causes can be sent by the CN function-1 (200A)/the CN function-2 (200B) on receiving UE's request. These causes can be based on PIN subscription issues or PIN session/mobility issues:

a. The PEMC device (100B) is not allowed: The requesting element cannot be made PEMC device (100B). Thus, requesting element should not request again in the signal-1 for The PEMC device (100B) optionally for the specific time, till the USIM of the UE (100) is removed or switched off and switch on (i.e., power cycle), etc.

b. The PEGC device (100C) is not allowed: The requesting element cannot be made the PEGC device (100C). Thus, requesting element should not request again in the signal-1 for the PEGC device (100C) optionally for the specific time, till the USIM is removed or switched off and switched on (i.e., power cycle), etc.

c. The PINE device (100A) is not allowed: The requesting element cannot be made PINE device (100A). Thus, requesting element should not request again in the signal-1 for the PINE device (100A) optionally for the specific time, till the USIM is removed or switched off and switched on (i.e., power cycle), etc.

d. The PINE device (100A) is not subscribed: The requested PIN-ID subscription is not valid. Thus, requesting element should not request again in the signal-1 for the respective PIN-ID optionally for the specific time, till the USIM is removed, etc, or switched off and switch on (i.e., power cycle).

e. The PINE device (100A) is not allowed in roaming: Requested PIN-ID is not allowed while the UE (100) is in a roaming connection. Thus, requesting element should not request again in the signal-1 for the respective PIN-ID optionally for the specific time, till the USIM is removed, etc, or switch off and switch on (i.e., power cycle).

f. The type of device or type of service or characteristics or device capability, capability, or group ID, is not allowed to join the PIN. Then, respective input parameters should not be requested by the PEGC device (100C)/PEMC device (100B)/PINE device (100A) for the specific time, till the USIM is removed, etc or switched off and switch on (i.e., power cycle).

g. In general, the specific time determined by a timer for any of the features in this embodiment can be pre-configured in the UE (100) or signalled by the network device (200) or the specific time can be chosen based on the implementation in the UE (100).

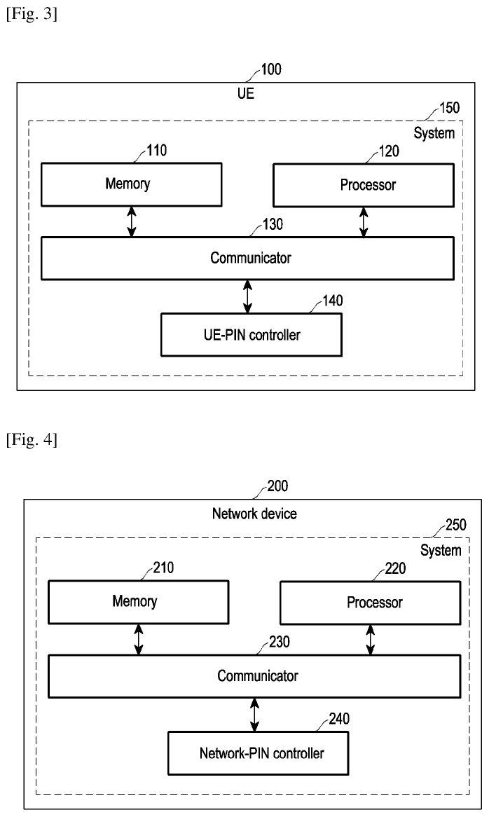

FIG. 3 illustrates a block diagram of the UE (100) for handling the PIN, according to an embodiment as disclosed herein. In an embodiment, the UE (100) comprises a system (150). The system (150) may include a memory (110), a processor (120), a communicator (130), and a UE-PIN controller (140).

In an embodiment, the memory (110) stores instructions to be executed by the processor (120) for handling the PIN, as discussed throughout the disclosure. The memory (110) may include non-volatile storage elements. Examples of such nonvolatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit, or it can be an external storage unit of the UE (100), a cloud storage, or any other type of external storage.

The processor (120) communicates with the memory (110), the communicator (130), and the UE-PIN controller (140). The processor (120) is configured to execute instructions stored in the memory (110) and to perform various processes for handling the PIN, as discussed throughout the disclosure. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g., server, network device, etc.) via one or more networks (e.g., Radio technology). The communicator (130) includes an electronic circuit specific to a standard that enables wired or wireless communication. For example, the communicator (130) may include a transceiver for wireless communication, or may include a communication interface for wired communication.

The UE-PIN controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the UE-PIN controller (140) sends the PIN input information to the network device (200) through the first message. The UE-PIN controller (140) further receives the PIN management information through the second message from the network device (200) in response to the sent PIN input information. The UE-PIN controller (140) further handles a plurality of UEs (100A-100N) registered in the PIN based on the received PIN management information. The PIN management information is determined by the network device (200) based on the received PIN input information.

In one or more embodiments, the UE-PIN controller (140) configures at least one UE of the plurality of UEs (100A-100N) as the PEGC device (100C) or the PEMC device (100B) or the PINE device (100A) based on the received PIN management information to handle the plurality of UEs (100A-100N).

In one or more embodiments, the UE-PIN controller (140) determines at least one of an implementation-specific parameter and a user input. The UE-PIN controller (140) then configures the UE (100) to operate as at least one of the PEGC device (100C), the PEMC device (100B), and the PINE device (100A) to access at least one 3^{rd} Generation Participation Project (3GPP) service of the network device (200), based on the at least one of the implementation-specific parameter and the user input.

In one or more embodiments, the UE-PIN controller (140) registers the at least one UE (100) with the network device (200) (e.g., PIN server, AMF, UDM, PCF, PEMC, etc.) based on the PIN management information. The UE-PIN controller (140) then provides access to the at least one registered UE (100) for at least one 3^{rd} Generation Participation Project (3GPP) service.

In one or more embodiments, the UE-PIN controller (140) authorizes the at least one UE (100) based on the PIN management information. The UE-PIN controller (140) then manages the at least one authorized UE (100).

In one or more embodiments, upon configuring the UE (100) as the PEGC device (100C), the PEGC device (100C) joins the PIN based on one or more PIN-IDs of the received PIN management information, wherein the one or more PIN-IDs represents the group ID.

In one or more embodiments, upon configuring the UE (100) as the PEGC device (100C), the PEGC device (100C) determines whether a total number of a plurality of PINE devices (100A) in the PIN exceeds a value of the maximum PINE number threshold. The PEGC device (100C) then performs one of allowing at least one PINE device (100A) of the plurality of PINE devices (100A) in the PIN in response to determining that the total number of the plurality of PINE devices (100A) in the PIN does not exceed the value of the maximum PINE number threshold or removing the at least one PINE device (100A) of the plurality of PINE devices (100A) in the PIN in response to determining that the total number of the plurality of PINE devices (100A) in the PIN exceeds the value of the maximum PINE number threshold.

In one or more embodiments, upon configuring the UE (100) as the PEGC device (100C), the PEGC device (100C) determines whether a total duration of the PINE device (100A) in the PIN exceeds a value of the maximum PINE duration. The PEGC device (100C) performs one of allowing the PINE device (100A) in the PIN in response to determining that the total duration of the PINE device (100A) in the PIN does not exceed the value of the maximum PINE duration or rejecting the PINE device (100A) in the PIN in response to determining that the total duration of the PINE device (100A) in the PIN exceeds the value of the maximum PINE duration.

In one or more embodiments, upon configuring the UE (100) as the PEGC device (100C), the PEGC device (100C) detects that the PEGC device (100C) is not in the predefined time slot. The PEGC device (100C) then performs at least one of: stopping function as the PEGC device (100C) in response to detecting that the PEGC device (100C) is not in the predefined time slot and sending a reject cause to the PEMC device (100B) in response to detecting that the PEGC device (100C) is not in the predefined time slot, wherein the PEMC device (100B) selects other PEGC device from the plurality of UEs (100A-100N).

In one or more embodiments, upon configuring the UE (100) as the PEGC device (100C), the PEGC device (100C) determines whether a total duration of the PEGC device (100C) in the PIN exceeds a value of the maximum PEGC duration. The PEGC device (100C) then performs at least one of: stopping function as the PEGC device (100C) in response to determining that the total duration of the PEGC device (100C) in the PIN exceeds the value of the maximum PEGC duration, releasing connection with all PINE devices (100A) associated with the PEGC device (100C) in response to determining that the total duration of the PEGC device (100C) in the PIN exceeds the value of the maximum PEGC duration, and sending a release indication to the PEMC device (100B) in response to determining that the total duration of the PEGC device (100C) in the PIN exceeds the value of the maximum PEGC duration.

In one or more embodiments, upon configuring the UE (100) as the PEGC device (100C), the PEGC device (100C) detects that a total duration of the PEGC device (100C) for each PIN-ID in the PIN exceeds a value of the maximum duration for each PIN-ID or the PEGC device (100C) is not in the predefined time slot as per the time slot information for each PIN-ID, or a total number of a plurality of PINE devices (100A) in the PIN does not exceed a value of the maximum threshold for each PIN-ID. The PEGC device (100C) then performs one of stopping function as the PEGC device (100C) in response to detecting that the total duration of the PEGC device (100C) for each PIN-ID in the PIN exceeds the value of the maximum duration for each PIN-ID, stopping function as the PEGC device (100C) in response to detecting that the PEGC device (100C) is not in the predefined time slot as per the time slot information for each PIN-ID, and allowing the PINE device (100A) in the PIN in response to detecting that total number of a plurality of PINE devices (100A) in the PIN does not exceed the value of the maximum threshold for each PIN-ID.

In one or more embodiments, upon configuring the UE (100) as the PEMC device (100B), the PEMC device (100B) joins the PIN based on one or more PIN-IDs of the received PIN management information, wherein the one or more PIN-IDs represents the group ID.

In one or more embodiments, upon configuring the UE (100) as the PEMC device (100B), the PEMC device (100B) determines whether a total number of a plurality of PINE devices (100A) in the PIN exceeds a value of the maximum PINE number threshold. The PEMC device (100B) then performs one of allowing at least one PINE device (100A) of the plurality of PINE devices (100A) in the PIN in response to determining that the total number of the plurality of PINE devices (100A) in the PIN does not exceed the value of the maximum PINE number threshold or removing the at least one PINE device (100A) of the plurality of PINE devices (100A) in the PIN in response to determining that the total number of the plurality of PINE devices (100A) in the PIN exceeds the value of the maximum PINE number threshold.

In one or more embodiments, upon configuring the UE (100) as the PEMC device (100B), the PEMC device (100B) determines whether a total duration of the PINE device (100A) in the PIN exceeds a value of the maximum PINE duration. The PEMC device (100B) then performs one of allowing the PINE device (100A) in the PIN in response to determining that the total duration of the PINE device (100A) in the PIN does not exceed the value of the maximum PINE duration or rejecting the PINE device (100A) in the PIN in response to determining that the total duration of the PINE device (100A) in the PIN exceeds the value of the maximum PINE duration.

In one or more embodiments, upon configuring the UE (100) as the PEMC device (100B), the PEMC device (100B) detects that the PEMC device (100B) is not in the predefined time slot. The PEMC device (100B) then performs at least one of: stopping function as the PEMC device (100B) in response to detecting that the PEMC device (100B) is not in the predefined time slot, and sending a reject cause to the PEGC device (100C) in response to detecting that the PEMC device (100B) is not in the predefined time slot, wherein the PEGC device (100C) selects other PEMC device from the plurality of UEs (100A-100N).

In one or more embodiments, upon configuring the UE (100) as the PEMC device (100B), the PEMC device (100B) determines whether a total duration of the PEMC device (100B) in the PIN exceeds a value of the maximum PEMC duration. The PEMC device (100B) then performs one of: stopping function as the PEMC device (100B) in response to determining that the total duration of the PEMC device (100B) in the PIN exceeds the value of the maximum PEMC duration, releasing connection with all PINE devices (100A) associated with the PEMC device (100B) in response to determining that the total duration of the PEMC device (100B) in the PIN exceeds the value of the maximum PEMC duration, and sending a release indication to the PEGC device (100C) in response to determining that the total duration of the PEMC device (100B) in the PIN exceeds the value of the maximum PEMC duration.

In one or more embodiments, upon configuring the UE (100) as the PEMC device (100B), the PEMC device (100B) detects that a total duration of the PEMC device (100B) for each PIN-ID in the PIN exceeds a value of the maximum duration for each PIN-ID or the PEMC device (100B) is not in the predefined time slot as per the time slot information for each PIN-ID, or a total number of a plurality of PINE devices (100A) in the PIN does not exceed a value of the maximum threshold for each PIN-ID. The PEMC device (100B) performs at least one of: stopping function as the PEMC device (100B) in response to detecting that the total duration of the PEMC device (100B) for each PIN-ID in the PIN exceeds the value of the maximum duration for each PIN-ID, stopping function as the PEMC device (100B) in response to detecting that the PEMC device (100B) is not in the predefined time slot as per the time slot information for each PIN-ID, and allowing the PINE device (100A) in the PIN in response to detecting that total number of the plurality of PINE devices (100A) in the PIN does not exceed the value of the maximum threshold for each PIN-ID.

In one or more embodiments, the UE-PIN controller (140) assigns a priority to a plurality of PEGC devices in the PIN. The UE-PIN controller (140) then determines that a PEGC device (100C) having a higher priority assigned among the plurality of PEGC devices is registered in the PIN and a total number of the plurality of PEGC devices in the PIN has reached a predefined threshold value. The UE-PIN controller (140) then removes a lower priority PEGC device assigned among the plurality of PEGC devices registered in the PIN in response to determining that the higher priority assigned among the plurality of PEGC devices is joined the PIN and the max number threshold is reached for the PIN.

In one or more embodiments, the PIN subscription data for the PEGC device (100C) and the PIN subscription data for the PEMC device (100B) are configured by an authorized user of the PIN or by the network device (200) e.g., PIN server.

Although FIG. 3 shows various hardware components of the UE (100), but it is to be understood that other embodiments are not limited thereon. In other embodiments, the UE (100) may include less or more number of components. Further, the labels or names of the components are used only for illustrative purpose and does not limit the scope of the disclosure. One or more components can be combined to perform the same or substantially similar functions to handle the PIN.

FIG. 4 illustrates a block diagram of the network device (200) for handling the PIN, according to an embodiment as disclosed herein. In an embodiment, the network device (200) comprises a system (250). The system (250) may include a memory (210), a processor (220), a communicator (230), and a network-PIN controller (240).

In an embodiment, the memory (210) stores instructions to be executed by the processor (220) for handling the PIN, as discussed throughout the disclosure. The memory (210) may include non-volatile storage elements. Examples of such nonvolatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) can be configured to store larger amounts of information than the memory. In certain examples, a non-transitory storage medium may store data that can, over time, change (e.g., in Random Access Memory (RAM) or cache). The memory (210) can be an internal storage unit, or it can be an external storage unit of the network device (200), a cloud storage, or any other type of external storage.

The processor (220) communicates with the memory (210), the communicator (230), and the network-PIN controller (240). The processor (220) is configured to execute instructions stored in the memory (210) and to perform various processes for handling the PIN, as discussed throughout the disclosure. The processor (220) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (230) is configured for communicating internally between internal hardware components and with external devices (e.g., UE (100)) via one or more networks (e.g., Radio technology, core network, etc.). The communicator (230) includes an electronic circuit specific to a standard that enables wired or wireless communication. For example, the communicator (230) may include a transceiver for wireless communication, and/or may include a communication interface for wired communication.

The network-PIN controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the network-PIN controller (240) receives the PIN input information from the UE (100) registered in the PIN through the first message. The network-PIN controller (240) further determines the PIN management information based on the received first message. The network-PIN controller (240) further sends the PIN management information to the UE (100) through the second message, wherein the UE (100) handles the PIN based on the received PIN management information.

In one or more embodiments, the network-PIN controller (240) may store the PIN input information and the PIN management information in the memory (210).

In one or more embodiments, the network-PIN controller (240) receives the first message comprising PIN input information from the UE (100). The network-PIN controller (240) further determines whether the PIN input information is valid. The network-PIN controller (240) further rejects the received first message in response to determining that the PIN input information is not valid. The network-PIN controller (240) further sends the reject cause to the UE (100).

In one or more embodiments, the reject cause indicates an identity of PIN (PIN-ID) for which the first message is rejected by the network device (200).

In one or more embodiments, the reject cause indicates the specific time duration for which the first message is rejected by the network device (200), wherein the specific time is pre-configured in the UE (100) or signaled by the network device (200) or based on the implementation-specific parameter.

In one or more embodiments, the reject cause is sent based on various conditions which are listed below.

a. The network device (200) detects that the PEGC device (100C) is not allowed to resend the first message for the specific time duration.

b. The network device (200) detects that the PINE device (100A) is not allowed to resend the first message for the specific time duration.

c. The network device (200) detects that the identity of the PIN (PIN-ID) subscription is not valid to resend the first message for the specific time duration.

d. The network device (200) detects that the requested PIN-ID is not valid to resend the first message for the specific time duration while the UE (100) is in the roaming connection.

e. The network device (200) detects that at least one of the type of the UE (100), the type of service associated with the UE (100), the characteristic of the UE (100), the identity of the group (group-ID), and the capability of the UE (100) is not valid to resend the first message for the specific time duration to join the PIN.

Although FIG. 4 shows various hardware components of the network device (200), but it is to be understood that other embodiments are not limited thereon. In other embodiments, the network device (200) may include less or more number of components. Further, the labels or names of the components are used only for illustrative purpose and does not limit the scope of the disclosure. One or more components can be combined to perform the same or substantially similar functions to handle the PIN.

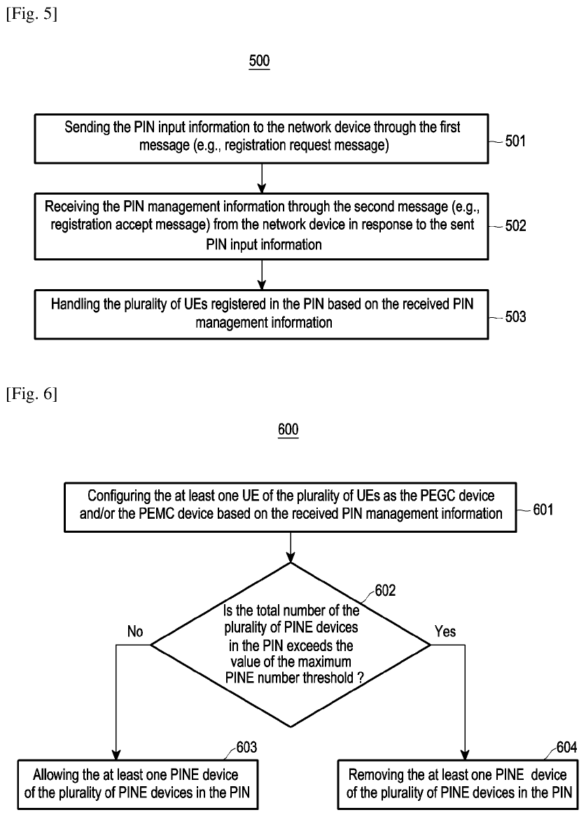

FIG. 5 is a flow diagram illustrating a method (500) for the UE (100) to handle the PIN, according to an embodiment as disclosed herein. Steps (501 to 503) are performed by the UE (100) to handle the PIN.

At step 501, the method (500) includes sending the PIN input information to the network device (200) through the first message, which relates to step 101. In one embodiment, the PIN input information comprises at least one of configuration information of the UE (100), the identity of PIN (PIN-ID), the request for PIN subscription data, the type of the UE (100), the type of service associated with the UE (100), the characteristic of the UE (100), the identity of group (group-ID), the capability of the UE (100), and the entity indication of the UE (100).

At step 502, the method (500) includes receiving the PIN management information through the second message from the network device (200) in response to the sent PIN input information, which relates to step 104. In one embodiment, the PIN management information is determined based on the received PIN input information. In one embodiment, the PIN management information comprises PIN subscription data, the PIN subscription data comprises at least one of the one or more PIN identities (PIN-IDs), the maximum PINE number threshold, the maximum PINE duration, the predefined time slot, the maximum PEGC duration, and the maximum PEMC duration, the maximum duration for each PIN-ID, the time slot information for each PIN-ID, and the maximum threshold for each PIN-ID.

At step 503, the method (500) includes handling the plurality of UEs (100A-100N) registered in the PIN based on the received PIN management information, which relates to step 104. In one embodiment, the method (500) includes configuring the at least one UE (100) of the plurality of UEs (100A-100N) as the PINE device (100A) or the PEGC device (100C) or the PEMC device (100B) based on the received PIN management information.

Additionally, the step 503 may include determining, by the UE (100), at least one of the implementation-specific parameter and the user input and configuring the UE (100) to operate as at least one of the PEGC device (100C), the PEMC device (100B), and the PINE device (100A) to access at least one 3^{rd} Generation Participation Project (3GPP) service of the network device (200) based on the at least one of the implementation-specific parameter and the user input, which relates to step 104.

Additionally, the step 503 may include registering the at least one UE (100) with the network device (200) based on the PIN management information and providing access to the at least one registered UE (100) for at least one 3^{rd} Generation Participation Project (3GPP) service, which relates to step 104.

Additionally, the step 503 may include authorizing the at least one UE (100) based on the PIN management information and managing the at least one authorized UE (100), which relates to step 104.

In one or more embodiments, other functionalities of the UE (100) associated with the step 503 are explained in FIG. 6 to FIG. 14.

FIG. 6 is a flow diagram illustrating a method (600) for allowing or removing the at least one PINE device (100A) of the plurality of PINE devices (100A) in the PIN based on the value of the maximum PINE number threshold, according to an embodiment as disclosed herein. Steps (601 to 604) are performed by the UE (100) to handle the PIN, which relates to step 104.

At step 601, the method (600) includes configuring the at least one UE (100) of the plurality of UEs (100A-100N) as the PEGC device (100C) and/or the PEMC device (100B) based on the received PIN management information. At step 602, the method (600) includes determining whether the total number of a plurality of PINE devices (100A) in the PIN exceeds the value of the maximum PINE number threshold. At step 603, the method (600) includes allowing at least one PINE device (100A) of the plurality of PINE devices (100A) in the PIN in response to determining that the total number of the plurality of PINE devices (100A) in the PIN does not exceed the value of the maximum PINE number threshold. At step 604, the method (600) includes removing the at least one PINE device (100A) of the plurality of PINE devices (100A) in the PIN in response to determining that the total number of the plurality of PINE devices (100A) in the PIN exceeds the value of the maximum PINE number threshold.

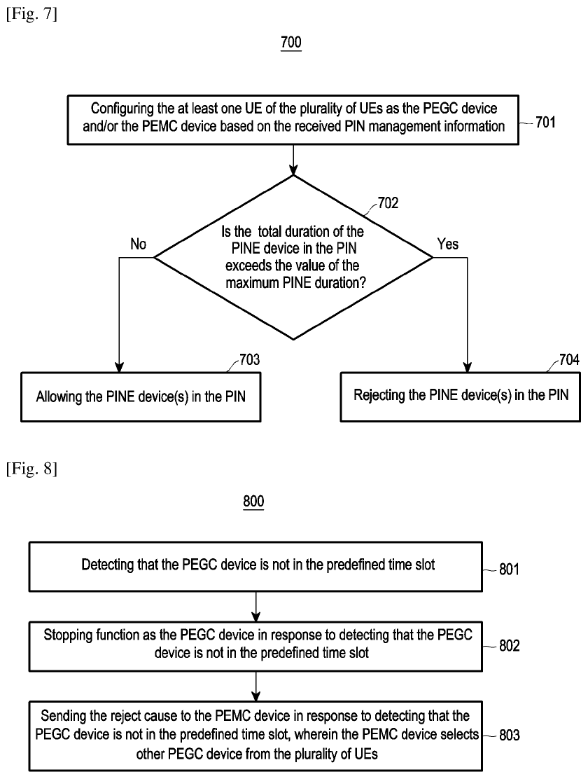

FIG. 7 is a flow diagram illustrating a method (700) for allowing or removing at least one PINE device (100A) of the plurality of PINE devices (100A) in the PIN based on the value of the maximum PINE duration, according to an embodiment as disclosed herein. Steps (701 to 704) are performed by the UE (100) to handle the PIN, which relates to step 104.

At step 701, the method (700) includes configuring the at least one UE (100) of the plurality of UEs (100A-100N) as the PEGC device (100C) and/or the PEMC device (100B) based on the received PIN management information. At step 702, the method (700) includes determining whether the total duration of the PINE device (100A) in the PIN exceeds the value of the maximum PINE duration. At step 703, the method (700) includes allowing the PINE device (100A) in the PIN in response to determining that the total duration of the PINE device (100A) in the PIN does not exceed the value of the maximum PINE duration. At step 704, the method (700) includes rejecting the PINE device (100A) in the PIN in response to determining that the total duration of the PINE device (100A) in the PIN exceeds the value of the maximum PINE duration.

FIG. 8 is a flow diagram illustrating a method (800) for configuring the UE (100) as the PEGC device (100C) based on the predefined time slot, according to an embodiment as disclosed herein. Steps (801 to 803) are performed by the UE (100) to handle the PIN, which relates to step 104.

At step 801, the method (800) includes detecting that the PEGC device (100C) is not in the predefined time slot. At step 802, the method (800) includes stopping function as the PEGC device (100C) in response to detecting that the PEGC device (100C) is not in the predefined time slot. At step 803, the method (800) includes sending the reject cause to the PEMC device (100B) in response to detecting that the PEGC device (100C) is not in the predefined time slot, wherein the PEMC device (100B) selects other PEGC device from the plurality of UEs (100A-100N).

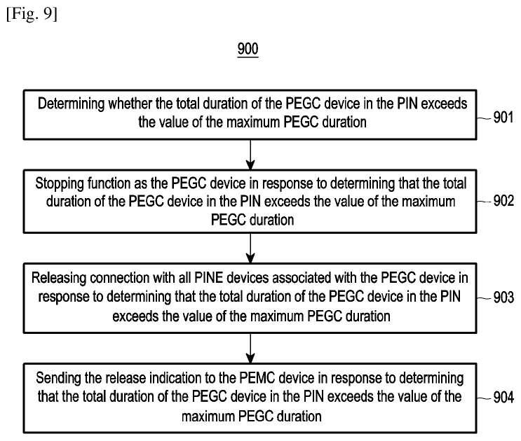

FIG. 9 is a flow diagram illustrating a method (900) for configuring the UE (100) as the PEGC device (100C) based on the value of a maximum PEGC duration, according to an embodiment as disclosed herein. Steps (901 to 904) are performed by the UE (100) to handle the PIN, which relates to step 104.

At step 901, the method (900) includes determining whether the total duration of the PEGC device (100C) in the PIN exceeds the value of the maximum PEGC duration. At step 902, the method (900) includes stopping function as the PEGC device (100C) in response to determining that the total duration of the PEGC device (100C) in the PIN exceeds the value of the maximum PEGC duration. At step 903, the method (900) includes releasing connection with all PINE devices (100A) associated with the PEGC device (100C) in response to determining that the total duration of the PEGC device (100C) in the PIN exceeds the value of the maximum PEGC duration. At step 904, the method (900) includes sending the release indication to the PEMC device (100B) in response to determining that the total duration of the PEGC device (100C) in the PIN exceeds the value of the maximum PEGC duration.

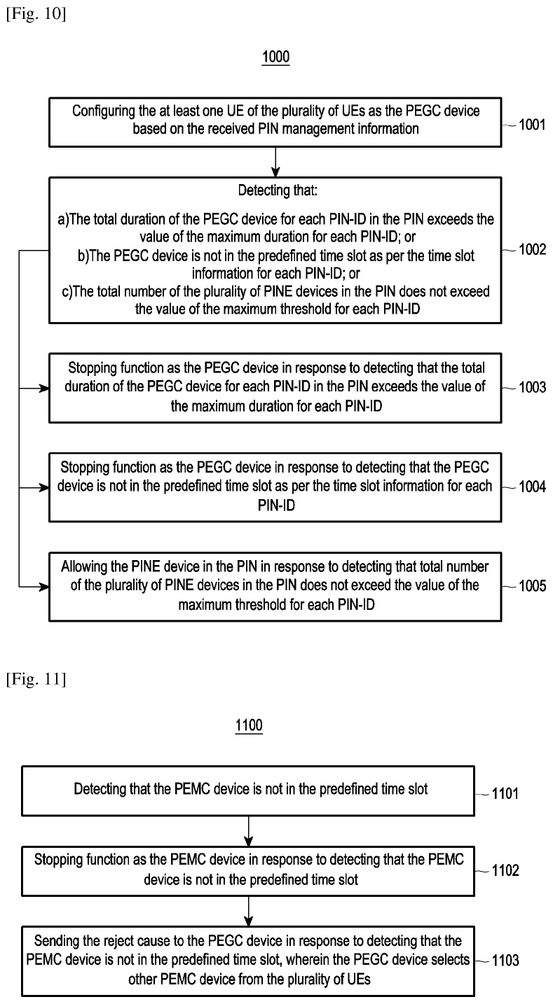

FIG. 10 is a flow diagram illustrating a method (1000) for configuring the UE (100) as the PEGC device (100C) based on the value of the maximum duration for each PIN-ID, the predefined time slot for each PIN-ID, and the value of a maximum threshold for each PIN-ID, according to an embodiment as disclosed herein. Steps (1001 to 1005) are performed by the UE (100) to handle the PIN, which relates to step 104.

At step 1001, the method (1000) includes configuring the at least one UE (100) of the plurality of UEs (100A-100N) as the PEGC device (100C) based on the received PIN management information. At step 1002, the method (1000) includes detecting that the total duration of the PEGC device (100C) for each PIN-ID in the PIN exceeds the value of the maximum duration for each PIN-ID or the PEGC device (100C) is not in the predefined time slot as per the time slot information for each PIN-ID, or the total number of the plurality of PINE devices (100A) in the PIN does not exceed the value of the maximum threshold for each PIN-ID.

At step 1003, the method (1000) includes stopping function as the PEGC device (100C) in response to detecting that the total duration of the PEGC device (100C) for each PIN-ID in the PIN exceeds the value of the maximum duration for each PIN-ID.

At step 1004, the method (1000) includes stopping function as the PEGC device (100C) in response to detecting that the PEGC device (100C) is not in the predefined time slot as per the time slot information for each PIN-ID.

At step 1005, the method (1000) includes allowing the PINE device (100A) in the PIN in response to detecting that the total number of the plurality of PINE devices (100A) in the PIN does not exceed the value of the maximum threshold for each PIN-ID.

FIG. 11 is a flow diagram illustrating a method (1100) for configuring the UE (100) as the PEMC device (100B) based on the predefined time slot, according to an embodiment as disclosed herein. Steps (1101 to 1103) are performed by the UE (100) to handle the PIN, which relates to step 104.

At step 1101, the method (1100) includes detecting that the PEMC device (100B) is not in the predefined time slot. At step 1102, the method (1100) includes stopping function as the PEMC device (100B) in response to detecting that the PEMC device (100B) is not in the predefined time slot. At step 1103, the method (1100) includes sending the reject cause to the PEGC device (100C) in response to detecting that the PEMC device (100B) is not in the predefined time slot, wherein the PEGC device (100C) selects other PEMC device from the plurality of UEs (100A-100N).

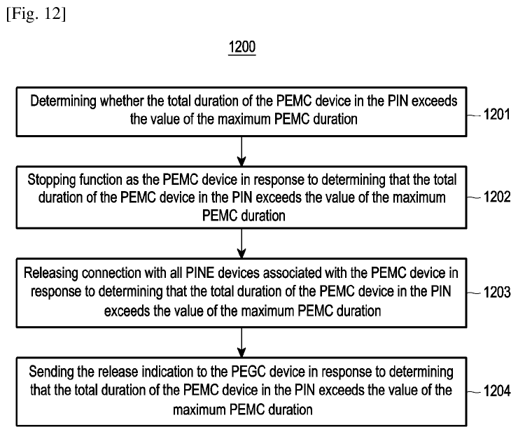

FIG. 12 is a flow diagram illustrating a method (1200) for configuring the UE (100) as the PEMC device (100B) based on the value of the maximum PEMC duration, according to an embodiment as disclosed herein. Steps (1201 to 1204) are performed by the UE (100) to handle the PIN, which relates to step 104.

At step 1201, the method (1200) includes determining whether the total duration of the PEMC device (100B) in the PIN exceeds the value of the maximum PEMC duration. At step 1202, the method (1200) includes stopping function as the PEMC device (100B) in response to determining that the total duration of the PEMC device (100B) in the PIN exceeds the value of the maximum PEMC duration. At step 1203, the method (1200) includes releasing connection with all PINE devices (100A) associated with the PEMC device (100B) in response to determining that the total duration of the PEMC device (100B) in the PIN exceeds the value of the maximum PEMC duration. At step 1204, the method (1200) includes sending the release indication to the PEGC device (100C) in response to determining that the total duration of the PEMC device (100B) in the PIN exceeds the value of the maximum PEMC duration.

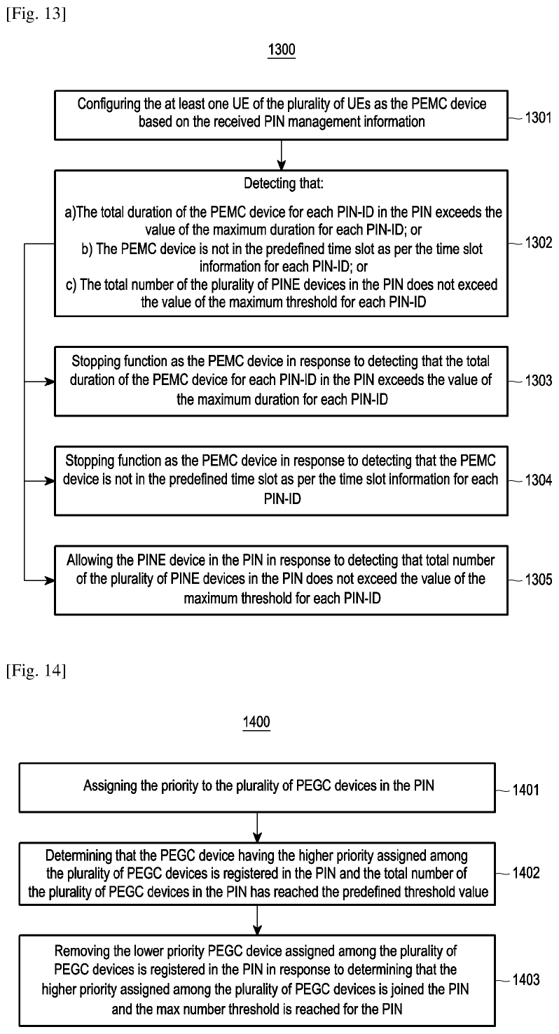

FIG. 13 is a flow diagram illustrating a method (1300) for configuring the UE (100) as the PEMC device (100B) based on the value of the maximum duration for each PIN-ID, the predefined time slot for each PIN-ID, and the value of the maximum threshold for each PIN-ID, according to an embodiment as disclosed herein. Steps (1301 to 1305) are performed by the UE (100) to handle the PIN, which relates to step 104.

At step 1301, the method (1300) includes configuring the at least one UE (100) of the plurality of UEs (100A-100N) as the PEMC device (100B) based on the received PIN management information. At step 1302, the method (1300) includes detecting that the total duration of the PEMC device (100B) for each PIN-ID in the PIN exceeds the value of the maximum duration for each PIN-ID or the PEMC device (100B) is not in the predefined time slot as per the time slot information for each PIN-ID, or the total number of the plurality of PINE devices (100A) in the PIN does not exceed the value of the maximum threshold for each PIN-ID.

At step 1303, the method (1300) includes the stopping function as the PEMC device (100B) in response to detecting that the total duration of the PEMC device (100B) for each PIN-ID in the PIN exceeds the value of the maximum duration for each PIN-ID.

At step 1304, the method (1300) includes the stopping function as the PEMC device (100B) in response to detecting that the PEMC device (100B) is not in the predefined time slot as per the time slot information for each PIN-ID.

At step 1305, the method (1300) includes allowing the PINE device (100A) in the PIN in response to detecting that the total number of the plurality of PINE devices (100A) in the PIN does not exceed the value of the maximum threshold for each PIN-ID.

FIG. 14 is a flow diagram illustrating a method (1400) for handling the PIN based on the priority of the PEGC device (100C), according to an embodiment as disclosed herein. Steps (1401 to 1403) are performed by the UE (100) to handle the PIN, which relates to step 104.

At step 1401, the method (1400) includes assigning the priority to the plurality of PEGC devices in the PIN. At step 1402, the method (1400) includes determining that the PEGC device (100C) having the higher priority assigned among the plurality of PEGC devices is registered in the PIN and the total number of the plurality of PEGC devices in the PIN has reached the predefined threshold value. At step 1403, the method (1400) includes removing the lower priority PEGC device assigned among the plurality of PEGC devices is registered in the PIN in response to determining that the higher priority assigned among the plurality of PEGC devices is joined to the PIN and the max number threshold is reached for the PIN.

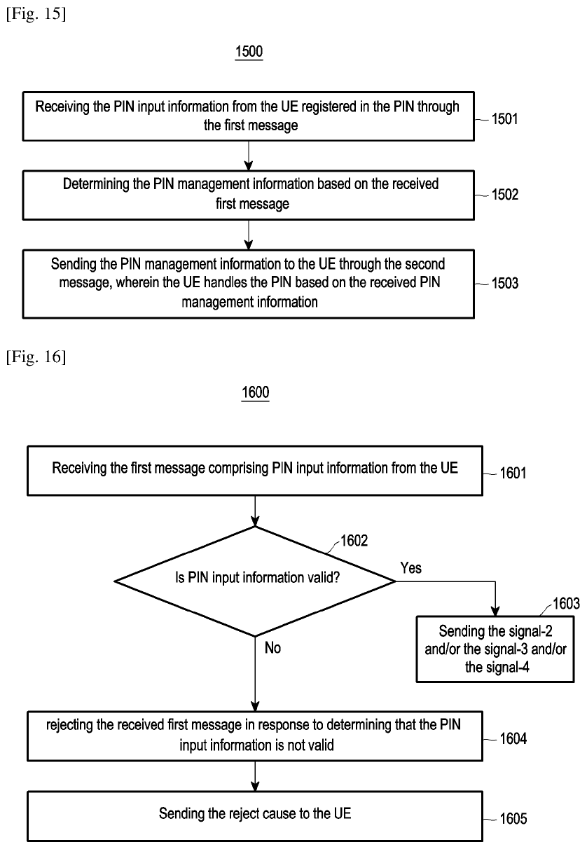

FIG. 15 is a flow diagram illustrating a method (1500) for the network device (200) to handle the PIN, according to an embodiment as disclosed herein. Steps (1501 to 1503) are performed by the network device (200) to handle the PIN.

At step 1501, the method (1500) includes receiving the PIN input information from the UE (100) registered in the PIN through the first message, which relates to step 101.

At step 1502, the method (1500) includes determining the PIN management information based on the received first message, which relates to steps 102-103.

At step 1503, the method (1500) includes sending the PIN management information to the UE (100) through the second message, wherein the UE (100) handles the PIN based on the received PIN management information, which relates to step 104.

Additionally, the step 1503 may include the network device (200) storing the PIN input information and the PIN management information.

FIG. 16 is a flow diagram illustrating a method (1600) for sending the reject cause by the network device (200) to the UE (100) based on the validation of PIN input information, according to an embodiment as disclosed herein. Steps (1601 to 1605) are performed by the network device (200) to handle the PIN.

At step 1601, the method (1600) includes receiving the first message comprising PIN input information from the UE (100), which relates to steps 101 and 201.

At step 1602, the method (1600) includes determining whether the PIN input information is valid, which relates to steps 101/201/203.

At step 1603, the method (1600) includes sending the signal-2 and/or the signal-3 and/or the signal-4 in response to determining that the PIN input information is valid, which relates to steps 102/103/104.

At step 1604, the method (1600) includes rejecting the received first message in response to determining that the PIN input information is not valid, which is related to step 201.

At step 1605, the method (1600) includes sending the reject cause to the UE (100), which relate to steps 202/204/205.

In an embodiment, a method (500) for handling a Personal IoT Network (PIN) is provided, wherein the method (500) comprises sending (501), by a User Equipment (UE) (100) registered in the PIN, PIN input information to a network device (200) through a first message, receiving (502), by the UE (100), PIN management information through a second message from the network device (200) in response to the sent PIN input information, and handling (503), by the UE (100), a plurality of UEs (100A-100N) registered in the PIN based on the received PIN management information.

In an embodiment, wherein the PIN input information comprises at least one of configuration information of the UE (100), an identity of PIN (PIN-ID), a request for PIN subscription data, a type of the UE (100), a type of service associated with the UE (100), a characteristic of the UE (100), an identity of group (group-ID), a capability of the UE (100), and an entity indication of the UE (100).

In an embodiment, wherein handling, by the UE (100), the plurality of UEs (100A-100N) registered in the PIN based on the received PIN management information comprises at least one of configuring at least one UE (100) of the plurality of UEs (100A-100N) as a PIN Element with Gateway Capability (PEGC) device (100C) based on the received PIN management information to handle the plurality of UEs (100A-100N), configuring at least one UE (100) of the plurality of UEs (100A-100N) as a PIN Element with Management Capability (PEMC) device (100B) based on the received PIN management information to handle the plurality of UEs (100A-100N), and configuring at least one UE (100) of the plurality of UEs (100A-100N) as a PIN Element (PINE) device (100A) based on the received PIN management information, wherein the PINE device (100A) is a non-3^{rd} Generation Participation Project (3GPP) device.

In an embodiment, wherein handling, by the UE (100), the plurality of UEs (100A-100N) registered in the PIN comprises determining, by the UE (100), at least one of an implementation-specific parameter and a user input, and configuring, by the UE (100) based on the at least one of the implementation-specific parameter and the user input, the UE (100) to operate as at least one of the PEGC device (100C), the PEMC device (100B), and the PINE device (100A) to access at least one 3^{rd} Generation Participation Project (3GPP) service of the network device (200).

In an embodiment, wherein configuring the at least one UE (100) of the plurality of UEs (100A-100N) as the PEGC device (100C) further comprises registering, by the PEGC device (100C), the at least one UE (100) with the network device (200) based on the PIN management information, and providing, by the PEGC device (100C), access to the at least one registered UE (100) for at least one 3^{rd} Generation Participation Project (3GPP) service.

In an embodiment, wherein configuring the at least one UE (100) of the plurality of UEs (100A-100N) as the PEMC device (100B) further comprises authorizing, by the PEMC device (100B), the at least one UE (100) based on the PIN management information, and managing, by the PEMC device (100B), the at least one authorized UE (100).

In an embodiment, wherein the PIN management information is determined based on the received PIN input information.

In an embodiment, wherein the PIN management information comprises PIN subscription data, the PIN subscription data comprises at least one of one or more PIN identities (PIN-IDs), a maximum PINE number threshold, a maximum PINE duration, a predefined time slot, a maximum PEGC duration and a maximum PEMC duration, a maximum duration for each PIN-ID, a time slot information for each PIN-ID, and a maximum threshold for each PIN-ID.

In an embodiment, wherein configuring the at least one UE (100) of the plurality of UEs (100A-100N) as the PEGC device (100C) based on the received PIN management information further comprises joining, by the PEGC device (100C), the PIN based on one or more PIN-IDs of the received PIN management information, wherein the one or more PIN-IDs represents a group ID.

In an embodiment, wherein configuring the at least one UE (100) of the plurality of UEs (100A-100N) as the PEGC device (100C) based on the received PIN management information further comprises determining, by the PEGC device (100C), whether a total number of a plurality of PINE devices (100A) in the PIN exceeds a value of the maximum PINE number threshold, and performing, by the PEGC device (100C), one of allowing at least one PINE device (100A) of the plurality of PINE devices (100A) in the PIN in response to determining that the total number of the plurality of PINE devices (100A) in the PIN does not exceed the value of the maximum PINE number threshold, or removing the at least one PINE device (100A) of the plurality of PINE devices (100A) in the PIN in response to determining that the total number of the plurality of PINE devices (100A) in the PIN exceeds the value of the maximum PINE number threshold.

In an embodiment, wherein configuring the at least one UE (100) of the plurality of UEs (100A-100N) as the PEGC device (100C) based on the received PIN management information further comprises determining, by the PEGC device (100C), whether a total duration of the PINE device (100A) in the PIN exceeds a value of the maximum PINE duration, and performing, by the PEGC device (100C), one of allowing the PINE device (100A) in the PIN in response to determining that the total duration of the PINE device (100A) in the PIN does not exceed the value of the maximum PINE duration, or rejecting the PINE device (100A) in the PIN in response to determining that the total duration of the PINE device (100A) in the PIN exceeds the value of the maximum PINE duration.

In an embodiment, wherein configuring the at least one UE (100) of the plurality of UEs (100A-100N) as the PEGC device (100C) based on the received PIN management information further comprises detecting, by the PEGC device (100C), that the PEGC device (100C) is not in the predefined time slot, and performing, by the PEGC device (100C), at least one of stopping function as the PEGC device (100C) in response to detecting that the PEGC device (100C) is not in the predefined time slot, and sending a reject cause to the PEMC device (100B) in response to detecting that the PEGC device (100C) is not in the predefined time slot, wherein the PEMC device (100B) selects other PEGC device from the plurality of UEs (100A-100N).

In an embodiment, wherein configuring the at least one UE (100) of the plurality of UEs (100A-100N) as the PEGC device (100C) based on the received PIN management information further comprises determining, by the PEGC device (100C), whether a total duration of the PEGC device (100C) in the PIN exceeds a value of the maximum PEGC duration, and performing, by the PEGC device (100C), at least one of stopping function as the PEGC device (100C) in response to determining that the total duration of the PEGC device (100C) in the PIN exceeds the value of the maximum PEGC duration, releasing connection with all PINE devices (100A) associated with the PEGC device (100C) in response to determining that the total duration of the PEGC device (100C) in the PIN exceeds the value of the maximum PEGC duration, and sending a release indication to the PEMC device (100B) in response to determining that the total duration of the PEGC device (100C) in the PIN exceeds the value of the maximum PEGC duration.

In an embodiment, wherein configuring the at least one UE (100) of the plurality of UEs (100A-100N) as the PEGC device (100C) based on the received PIN management information further comprises detecting, by the PEGC device (100C), that a total duration of the PEGC device (100C) for each PIN-ID in the PIN exceeds a value of the maximum duration for each PIN-ID or the PEGC device (100C) is not in the predefined time slot as per the time slot information for each PIN-ID, or a total number of a plurality of PINE devices (100A) in the PIN does not exceed a value of the maximum threshold for each PIN-ID, and performing, by the PEGC device (100C), at least one of stopping function as the PEGC device (100C) in response to detecting that the total duration of the PEGC device (100C) for each PIN-ID in the PIN exceeds the value of the maximum duration for each PIN-ID, stopping function as the PEGC device (100C) in response to detecting that the PEGC device (100C) is not in the predefined time slot as per the time slot information for each PIN-ID, and allowing the PINE device (100A) in the PIN in response to detecting that the total number of a plurality of PINE devices (100A) in the PIN does not exceed the value of the maximum threshold for each PIN-ID.

In an embodiment, wherein configuring the at least one UE (100) of the plurality of UEs (100A-100N) as the PEMC device (100B) based on the received PIN management information further comprises joining, by the PEMC device (100B), the PIN based on one or more PIN-IDs of the received PIN management information, wherein the one or more PIN-IDs represents a group ID.

In an embodiment, wherein configuring the at least one UE (100) of the plurality of UEs (100A-100N) as the PEMC device (100B) based on the received PIN management information further comprises determining, by the PEMC device (100B), whether a total number of a plurality of PINE devices (100A) in the PIN exceeds a value of the maximum PINE number threshold, and performing, by the PEMC device (100B1), one of allowing at least one PINE device (100A) of the plurality of PINE devices (100A) in the PIN in response to determining that the total number of the plurality of PINE devices (100A) in the PIN does not exceed the value of the maximum PINE number threshold, or removing the at least one PINE device (100A) of the plurality of PINE devices (100A) in the PIN in response to determining that the total number of the plurality of PINE devices (100A) in the PIN exceeds the value of the maximum PINE number threshold.

In an embodiment, wherein configuring the at least one UE (100) of the plurality of UEs (100A-100N) as the PEMC device (100B) based on the received PIN management information further comprises determining, by the PEMC device (100B), whether a total duration of the PINE device (100A) in the PIN exceeds a value of the maximum PINE duration, and performing, by the PEMC device (100B), one of allowing the PINE device (100A) in the PIN in response to determining that the total duration of the PINE device (100A) in the PIN does not exceed the value of the maximum PINE duration, or rejecting the PINE device (100A) in the PIN in response to determining that the total duration of the PINE device (100A) in the PIN exceeds the value of the maximum PINE duration.

In an embodiment, wherein configuring the at least one UE (100) of the plurality of UEs (100A-100N) as the PEMC device (100B) based on the received PIN management information further comprises detecting, by the PEMC device (100B), that the PEMC device (100B) is not in the predefined time slot, and performing, by the PEMC device (100B), at least one of stopping function as the PEMC device (100B) in response to detecting that the PEMC device (100B) is not in the predefined time slot, and sending a reject cause to the PEGC device (100C) in response to detecting that the PEMC device (100B) is not in the predefined time slot, wherein the PEGC device (100C) selects other PEMC device from the plurality of UEs (100A-100N).

In an embodiment, wherein configuring the at least one UE (100) of the plurality of UEs (100A-100N) as the PEMC device (100B) based on the received PIN management information further comprises determining, by the PEMC device (100B), whether a total duration of the PEMC device (100B) in the PIN exceeds a value of the maximum PEMC duration, and performing, by the PEMC device (100B), at least one of stopping function as the PEMC device (100B) in response to determining that the total duration of the PEMC device (100B) in the PIN exceeds the value of the maximum PEMC duration, releasing connection with all PINE devices (100A) associated with the PEMC device (100B) in response to determining that the total duration of the PEMC device (100B) in the PIN exceeds the value of the maximum PEMC duration, and sending a release indication to the PEGC device (100C) in response to determining that the total duration of the PEMC device (100B) in the PIN exceeds the value of the maximum PEMC duration.

In an embodiment, wherein configuring the at least one UE (100) of the plurality of UEs (100A-100N) as the PEMC device (100B) based on the received PIN management information further comprises detecting, by the PEMC device (100B), that a total duration of the PEMC device (100B) for each PIN-ID in the PIN exceeds a value of the maximum duration for each PIN-ID or the PEMC device (100B) is not in the predefined time slot as per the time slot information for each PIN-ID, or a total number of a plurality of PINE devices (100A) in the PIN does not exceed a value of the maximum threshold for each PIN-ID, and performing, by the PEMC device (100B), at least one of stopping function as the PEMC device (100B) in response to detecting that the total duration of the PEMC device (100B) for each PIN-ID in the PIN exceeds a value of the maximum duration for each PIN-ID, stopping function as the PEMC device (100B) in response to detecting that the PEMC device (100B) is not in the predefined time slot as per the time slot information for each PIN-ID, and allowing the PINE device (100A) in the PIN in response to detecting that the total number of the plurality of PINE devices (100A) in the PIN does not exceed the value of the maximum threshold for each PIN-ID.

In an embodiment, wherein handling the PIN based on the received PIN management information comprises assigning, by the UE (100), a priority to a plurality of PEGC devices in the PIN, determining, by the UE (100), that a PEGC device (100C) having a higher priority assigned among the plurality of PEGC devices is registered in the PIN and a total number of the plurality of PEGC devices in the PIN has reached a predefined threshold value, and removing, by the UE (100), a lower priority PEGC device assigned among the plurality of PEGC devices is registered in the PIN in response to determining that the higher priority assigned among the plurality of PEGC devices is joined the PIN and the max number threshold is reached for the PIN.

In an embodiment, wherein the PIN subscription data for the PEGC device (100C) and the PIN subscription data for the PEMC device (100B) are configured by an authorized user of the PIN.

In an embodiment, a method (1500) for handling a Personal IoT Network (PIN) is provided, wherein the method (1500) comprises receiving (1501), by a network device (200), PIN input information from a User Equipment (UE) (100) registered in the PIN through a first message, determining (1502), by the network device (200), PIN management information based on the received first message, and sending (1503), by the network device (200), the PIN management information to the UE (100) through a second message, wherein the UE (100) handles the PIN based on the received PIN management information.

In an embodiment, wherein the network device (200) stores the PIN input information and the PIN management information.

In an embodiment, wherein the method comprises receiving, by the network device (200), the first message comprising PIN input information from the UE (100), determining, by the network device (200), whether the PIN input information is valid, rejecting, by the network device (200), the received first message in response to determining that the PIN input information is not valid, and sending, by the network device (200), a reject cause to the UE (100).

In an embodiment, wherein the reject cause indicates an identity of PIN (PIN-ID) for which the first message is rejected by the network device (200).

In an embodiment, wherein the reject cause indicates a specific time duration for which the first message is rejected by the network device (200), wherein the specific time is pre-configured in the UE (100) or signaled by the network device (200) or based on an implementation-specific parameter.

In an embodiment, wherein the reject cause is sent based on at least one of detection, by the network device (200), that a PIN Element with Management Capability (PEMC) device (100B) is not allowed to resend the first message for a specific time duration, detection, by the network device (200), that a PIN Element with Gateway Capability (PEGC) device (100C) is not allowed to resend the first message for the specific time duration, detection, by the network device (200), that a PIN Element (PINE) device (100A) is not allowed to resend the first message for the specific time duration, detection, by the network device (200), that an identity of PIN (PIN-ID) subscription is not valid to resend the first message for the specific time duration, detection, by the network device (200), that a requested PIN-ID is not valid to resend the first message for the specific time duration while the UE (100) is in a roaming connection, and detection, by the network device (200), that at least one of a type of the UE (100), a type of service associated with the UE (100), a characteristic of the UE (100), an identity of group (group-ID), and a capability of the UE (100) is not valid to resend the first message for the specific time duration to join the PIN.

In an embodiment, a system/device (150) for handling a Personal IoT Network (PIN) is provided, wherein the system/device (150) comprises a memory (110), a processor (120), and a UE-PIN controller (140), operably connected to the memory (110) and the processor (120), configured to send PIN input information to a network device (200) through a first message, receive PIN management information through a second message from the network device (200) in response to sending the first message, and handle a plurality of UEs (100A-100N) registered in the PIN based on the received PIN management information.

In an embodiment, a system/device (250) for handling a Personal IoT Network (PIN) is provided, wherein the system/device (250) comprises a memory (210), a processor (220), and a network-PIN controller (240), operably connected to the memory (210) and the processor (220), configured to receive PIN input information from a User Equipment (UE) (100) registered in the PIN through a first message, determine PIN management information based on the received first message, and send the PIN management information to the UE (100) through a second message, wherein the UE (100) handles the PIN based on the received PIN management information.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a personal internet of things (IoT) network (PIN) element (PINE) in a wireless communication system supporting a PIN, the method comprising:
transmitting, to a PIN server, a registration request message including capability information of the PINE in a registration procedure for the PINE; and
receiving, from the PIN server, a registration response message indicating whether the registration procedure for the PINE is successful, based on the registration request message,
wherein the capability information of the PINE is capable of becoming at least one of a PIN element with gateway capability (PEGC) and a PIN element with management capability (PEMC) in the PIN.

17. The method of claim 16, wherein the PINE acts as at least one of the PEGC and the PEMC in case that whether the registration request of the PINE is successful.

18. The method of claim 16, wherein the PINE includes at least one of the PEGC and the PEMC, and
wherein, in case that the PEMC transmits the registration request message, the registration request message further includes a PIN ID for which the PINE intends to register as the PEMC.

19. The method of claim 16, wherein the registration request message further includes at least one of information on a service that the PINE supports and device information of the PINE.

20. The method of claim 16, wherein the registration response message further includes information indicating a cause of a registration request failure in case that the registration procedure for the PINE fails.

21. The method of claim 16, wherein the PINE is included in a user equipment (UE) in the wireless communication system.

22. A personal internet of things (IoT) network (PIN) element (PINE) device in a wireless communication system supporting a PIN, the PINE device comprising:
a communicator; and
a processor configured to:
transmit, to a PIN server via the communicator, a registration request message including capability information of the PINE device in a registration procedure for the PINE device, and
receive, via the communicator from the PIN server, a registration response message indicating whether the registration procedure for the PINE device is successful, based on the registration request message,
wherein the capability information of the PINE device is capable of becoming at least one of a PIN element with gateway capability (PEGC) device and a PIN element with management capability (PEMC) device.

23. The PINE device of claim 22, wherein the PINE acts as at least one of the PEGC and the PEMC in case that whether the registration request of the PINE is successful.

24. The PINE device of claim 22, wherein the PINE includes at least one of the PEGC and the PEMC, and
wherein, in case that the PEMC transmits the registration request message, the registration request message further includes a PIN ID for which the PINE intends to register as the PEMC.

25. The PINE device of claim 22, wherein the registration request message further includes at least one of information on a service that the PINE supports and device information of the PINE.

26. The PINE device of claim 22, wherein the registration response message further includes information indicating a cause of a registration request failure in case that the registration procedure for the PINE fails.

27. The PINE device of claim 22, wherein the PINE is included in a user equipment (UE) in the wireless communication system.

28. A method performed by a personal internet of things (IoT) network (PIN) server in a wireless communication system supporting a PIN, the method comprising:
receiving, from a PIN, element, PINE, a registration request message including capability information of the PINE in a registration procedure for the PINE; and
transmitting, to the PINE, a registration response message indicating whether the registration procedure for the PINE is successful based on the registration request message,
wherein the capability information of the PINE is capable of becoming at least one of a PIN element with gateway capability (PEGC) and a PIN element with management capability (PEMC).

29. The method of claim 28, wherein the PIN server authorizes the PINE to act as at least one of the PEGC and the PEMC in case that whether the registration request of the PINE is successful.

30. The method of claim 28, wherein the PINE includes at least one of the PEGC and the PEMC, and
wherein, in case that the PIN server receives, from the PEMC, the registration request message, the registration request message further includes a PIN ID for which the PINE intends to register as the PEMC.

31. The method of claim 28, wherein the registration request message further includes at least one of information on a service that the PINE supports and device information of the PINE, and
wherein the registration response message further includes information indicating a cause of a registration request failure in case that the registration procedure for the PINE fails.

32. A personal internet of things (IoT) network (PIN) server in a wireless communication system supporting a PIN, the PIN server comprising:
a communicator; and
a processor configured to:
receiving, via the communicator from a PIN, element, PINE, device, a registration request message including capability information of the PINE in a registration procedure for the PINE device; and
transmitting, to the PINE device via the communicator, a registration response message indicating whether the registration request of the PINE device is successful based on the registration request message,
wherein the capability information of the PINE device is capable of becoming at least one of a PIN element with gateway capability (PEGC) device and a PIN element with management capability (PEMC) device.

33. The PIN server of claim 32, wherein the PIN server authorizes the PINE to act as at least one of the PEGC and the PEMC in case that whether the registration request of the PINE is successful.

34. The PIN server of claim 32, wherein the PINE includes at least one of the PEGC and the PEMC, and
wherein, in case that the PIN server receives, from the PEMC, the registration request message, the registration request message further includes a PIN ID for which the PINE intends to register as the PEMC.

35. The PIN server of claim 32, wherein the registration request message further includes at least one of information on a service that the PINE supports and device information of the PINE, and
wherein the registration response message further includes information indicating a cause of a registration request failure in case that the registration procedure for the PINE fails.
